(19) United States
(12) Patent Application Publication
(10) Pub. No.: US 2024/0347811 A1
(43) Pub. Date: Oct. 17, 2024

(54) BATTERY MODULE HAVING INTERMEDIATE PARTS, ASSOCIATED BATTERY AND VEHICLE

(71) Applicants: PSA AUTOMOBILES SA, Poissy (FR); SAFT, LEVALLOIS PERRET (FR)

(72) Inventors: Nicolas CHAURIS, VERNON (FR); Mathieu GALVAING, NIEUIL L'ESPOIR (FR); Guillaume TATRIE, Bois D Arcy (FR); Maximilien PERQUIA, St Cyr L Ecole (FR)

(21) Appl. No.: 18/700,068

(22) PCT Filed: Sep. 28, 2022
(86) PCT No.: PCT/FR2022/051832

§ 371 Date: Apr. 10, 2024

(30) Foreign Application Priority Data
Oct. 22, 2021 (FR) 2111243

(51) Int. Cl. H01M 10/6557; H01M 10/613; H01M 10/625; H01M 10/6568; H01M 50/211; H01M 50/249

(52) U.S. Cl. CPC H01M 10/6557; H01M 10/613; H01M 10/625; H01M 10/6568; H01M 50/211; H01M 50/249

(57) ABSTRACT

This module comprises a stack, comprising: * a plurality of electrochemical cells (18); * at least one intermediate part (20) interposed between each pair of adjacent cells (18); * a mechanism for holding the stack clamping the cells (18) and the intermediate parts (20) against one another. The module comprises at least one dielectric liquid for cooling the stack. The intermediate part (20) defines at least one open channel (82A, 82B) for flow of the dielectric liquid. The channel (82A, 82B) opens onto the periphery of the stack in order to allow the dielectric liquid to flow through the stack and opens facing a main face (74, 76) of at least one cell (18), which face is applied against the intermediate part (20), in order to place the main face (74, 76) in contact with the dielectric liquid.

### CROSS-REFERENCE TO RELATED APPLICATIONS

This application is the US National Stage under 35 USC § 371 of International Application No. PCT/FR2022/051832, filed Sep. 28, 2022, which claims the priority of French application 2111243 filed on Oct. 22, 2021, the content (text, drawings and claims) of both said applications being incorporated by reference herein.

### BACKGROUND

Related herein is a battery module comprising:
a housing defining an interior volume;
a stack comprising;
   a plurality of electrochemical cells stacked in the interior volume;
   at least one intermediate part interposed between each pair of adjacent electrochemical cells;
   a mechanism for holding the stack suitable for clamping the electrochemical cells and the intermediate parts against one another; the stack being contained in the interior volume;
at least one dielectric liquid for cooling the stack.

Such a module is intended to be used in particular in applications for supplying electrical power in the automotive industry, space, or/and for energy storage. Such a module is particularly suitable for applications with high electrical power.

The ecological transition requires batteries wherein the electrical power levels involved are increasingly high, both during the supply of a current and a voltage to a consumer system, and during the recharging of the battery module.

In this context, a battery module of the aforementioned type generally undergoes significant heating which requires efficient discharge of the calories produced by the Joule effect.

In addition, when the battery module comprises cells, in particular lithium-ion cells, consisting of flexible envelopes (known as “pouches”) or rigid envelopes in prismatic shape, they tend to swell, in particular during the recharging of the battery module. It is therefore necessary to ensure that the battery module and electrochemical cells have adequate mechanical strength during its use.

To solve the aforementioned problems, US 2016/0164061 proposes a solution wherein electrochemical cells are stacked on one another with a heat dissipation plate being interposed between each pair of adjacent cells.

The plate has lateral fins, which extend transversely from the stack. It transfers the heat produced in the cells by thermal conduction to the fins. Furthermore, a duct, wherein a cooling liquid circulates, passes through the fins. Thus, the calories present in the fins are transferred outside the battery module via the cooling liquid.

However, such a battery module is not entirely satisfactory.

Firstly, the heat exchange by conduction allows only a limited discharge of the calories, which can cause problems in certain high-power applications.

Furthermore, the module provided with the dissipating plates is heavy and bulky, in particular due to the presence of the fins, which is a major drawback for embedded applications as in the automotive, space, and aeronautical sectors.

### SUMMARY

One aim is therefore to provide a battery module wherein the calories generated during the delivery of electrical power, or during the recharging of the module, are discharged very effectively, the module remaining compact and mechanically intact, and adaptable to various connections.

To this end, a battery module of the aforementioned type is described herein, characterized in that the dielectric fluid fills the interior volume, the stack being totally immersed in the dielectric fluid,
the or each intermediate part defining at least one open channel for flow of the dielectric fluid, the open channel for flow of the dielectric fluid opening onto the periphery of the stack to allow the dielectric fluid to flow through the stack and opening facing a main face of at least one electrochemical cell, which face is applied against the intermediate part, in order to place the main face of the electrochemical cell into contact with the dielectric fluid.

The battery module may comprise one or more of the following features, taken in isolation or according to any technically possible combination(s):
the at least one intermediate part defines a plurality of open channels for flow of the dielectric fluid separated from each other;
the or each intermediate part defines at least one first open channel for flow of the dielectric fluid opening toward a first main face of a first electrochemical cell adjacent to the intermediate part, and closed toward a second main face of a second electrochemical cell adjacent to the intermediate part, located opposite the first electrochemical cell relative to the intermediate part, the intermediate part comprising at least one second open channel for flow of the dielectric fluid opening toward the second main face of the second electrochemical cell, and closed toward the first main face of the first electrochemical cell;
a bottom of the first open channel for flow of the dielectric fluid is applied against the second main face of the second electrochemical cell, a bottom of the second open channel for flow of the dielectric fluid being applied to the first main face of the first electrochemical cell;
the open channel for flow of the dielectric fluid opens at the periphery of the stack via at least two distinct openings;
the two distinct openings open into two distinct faces of the stack, advantageously into two opposite or adjacent faces of the stack, or the two distinct openings open into the same face of the stack;
the area of the cross-section of each open channel for flow of the dielectric fluid is less than 2 mm², and in particular between 0.5 mm² and 2 mm²;
the housing defines an inlet for supplying dielectric fluid into the interior volume and an outlet for discharging dielectric fluid out from the interior volume, the supply inlet and the discharge outlet being intended to be connected to a dielectric fluid cooling circuit advantageously comprising a pump;
the holding mechanism comprises two end flanges, arranged on either side of the stack, and at least one tie rod connecting the two end flanges, at least one of the end flanges comprises an inner face intended to be placed opposite an electrochemical cell of the stack, the inner face being curved before clamping the stack by means of the tie rod and flattening on a main face of an electrochemical cell after the stack is clamped by means of the tie rod;
the housing comprises a lateral access opening and an opposite internal face located opposite the lateral access opening, the holding mechanism comprising at least one hatch for closing the lateral access opening able to compress the stack between the hatch and the opposite face;
each electrochemical cell defines at least one electrical connection tab protruding relative to the stack, the electrical connection tabs being immersed in the dielectric liquid;
the battery module comprises at least one connection system and/or at least one electronic system for managing the battery module connected to each electrical connection tab, the connection system and/or the electronic management system being immersed in the dielectric liquid;
each electrochemical cell comprises a pouch, which in particular is a lithium ion electrochemical cell in a pouch format or wherein each electrochemical cell comprises an element of prismatic shape, the dielectric liquid present in the or each open channel for flow of the dielectric fluid being in contact with the pouch or the prismatic element.

Also described is a battery comprising at least one battery module as defined above, in particular a plurality of battery modules as defined above.

The battery advantageously comprises a circuit for cooling the dielectric liquid, connected to the battery module, supplying the or each open channel for flow of the dielectric fluid.

Also described is a vehicle, in particular a motor vehicle, spacecraft, or aircraft, comprising a battery as defined above.

Also described is a method for generating electrical power from a battery module or for recharging a battery module, comprising the following steps:
providing a battery module as defined above;
generating electrical power from electrochemical cells of the battery module, or recharging electrochemical cells from an external electrical power;
during the generation of electrical power or the refill, circulating the dielectric fluid through the or each open channel for flow of the dielectric fluid to discharge the calories produced by the electrochemical cells by convection on at least one main face.

### BRIEF DESCRIPTION OF THE DRAWINGS

The described devices will be better understood upon reading the following description, given solely as example, and made with reference to the appended drawings, wherein:

FIG. 1 is an exploded perspective view of a first battery module.

FIG. 2 is an exploded perspective view of a stack of the battery module of FIG. 1, comprising two electrochemical cells, separated by an intermediate part defining open channels.

FIG. 3 is a sectional view taken along a longitudinal axial plane of a detail of the stack contained in the module of FIG. 1.

FIG. 4 is an exploded perspective view of the stack contained in the battery module of FIG. 1.

FIG. 5 is a view in section along a horizontal plane of the end flanges of the stack of FIG. 4, (a) before tightening the gripping mechanism and (b) after tightening the holding mechanism.

FIG. 6 is a view illustrating an intermediate part of a second battery module, and next to the intermediate part, the schematic representation of the flow of liquid running through the intermediate part.

FIG. 7 is a view analogous to FIG. 6, for a third battery module.

FIG. 8 is a view analogous to FIG. 6 for a fourth battery module.

FIG. 9 is a schematic side view of a fifth battery module.

### DETAILED DESCRIPTION

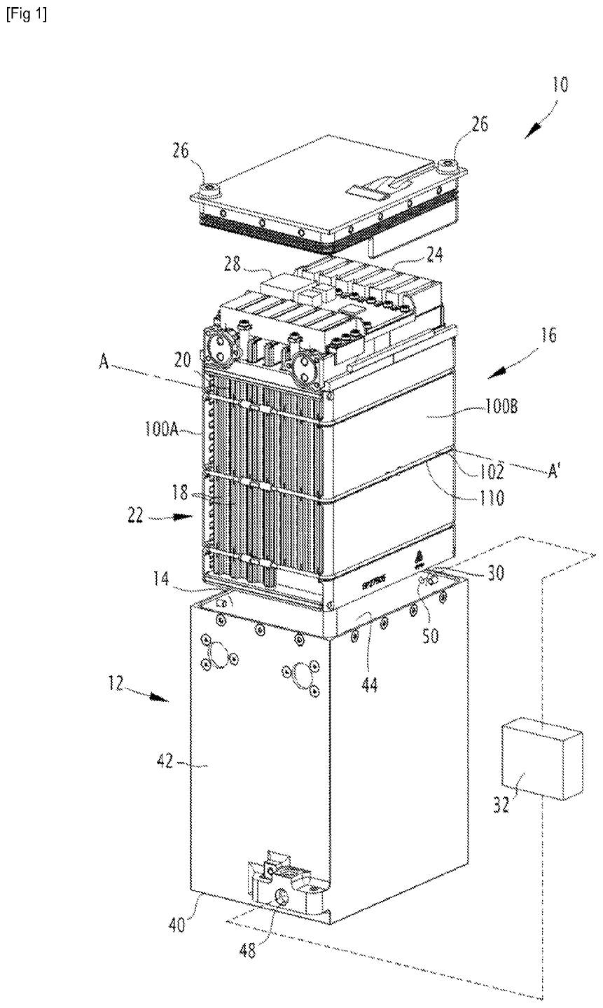

A first battery module 10 is schematically shown in FIGS. 1 to 5. The battery module 10 is intended to be integrated into a battery system (not shown) comprising one or more identical battery modules 10.

The battery module 10 comprises a housing 12, defining an inner volume 14. It further comprises a stack 16 received in the interior volume 14, the stack 16 comprising a plurality of electrochemical cells 18, intermediate parts 20 separating each pair of adjacent electrochemical cells 18, and a mechanism 22 for holding the electrochemical cells 18 and intermediate parts 20.

The battery module 10 further comprises a connection system 24 intended to connect the electrochemical cells 18 to terminals 26 and an electronic battery management system 28, the connection system 24 and the electronic management system 28 also being arranged in the interior volume 14.

The interior volume 14 of the housing 12 is furthermore filled with a dielectric liquid 30, wherein the stack 16, the connection system 24, the terminals 26, and the electronic management system 28 are immersed.

The battery module 10 is connected to a cooling circuit 32 ensuring the flow of the dielectric fluid in the interior volume 14 and the discharging of the calories it contains, out from the battery module 10.

With reference to FIG. 1, the housing 12 comprises a bottom 40, and lateral walls 42 protruding relative to the bottom 40.

In this example, the housing 12 comprises four lateral walls 42 perpendicular two-by-two, defining the inner volume 14 therebetween and with the bottom 40.

The lateral walls 42 further define an upper opening 44 for access to the interior volume 14.

The housing 12 further comprises a cover 46 for removably closing the access opening 44 in order to allow the stack 16 to be loaded into the interior volume 14 and possibly unloaded therefrom.

The housing 12 further delimits an inlet 48 for supplying dielectric fluid into the interior volume 14 and an outlet 50 for discharging the dielectric fluid out from the interior volume 14. The supply inlet 48 and the discharge outlet 50 are each connected to the cooling circuit 32.

In the example shown in FIG. 1, the supply inlet 48 is located in the vicinity of the bottom 40, on a lateral wall 42. The discharge outlet 50 is located in the vicinity of the access opening 44, on a lateral wall 42 opposite that where the supply inlet 48 is located.

In this example, the stack 16 extends along an axis A-A′ parallel to the bottom 40 of the interior volume 14 of the housing 12 when the stack 16 is received in the interior volume 14.

The stack 16 comprises more than five electrochemical cells 18, preferably between 5 and 20 electrochemical cells 18 stacked against one another with an intermediate part 20 interposed between each pair of adjacent electrochemical cells 18.

In this example, each electrochemical cell 18 comprises an outer envelope or pouch 60 containing a plurality of electrodes (not shown) of opposite polarities, arranged in the pouch 60 and separated from each other by an internal separator (not shown).

The flexible envelope or pouch 60 advantageously is formed after welding the edges of two multi-layer films, each multi-layer film comprising a metal layer, generally made of aluminum, sandwiched between two layers of plastic material. The envelope thus formed is filled with the electrodes of opposite polarities separated by an internal separator, with an electrolyte, and is then closed in a sealed manner.

The pouch 60 is advantageously deformable to the touch.

Alternatively, the electrochemical cell 18 comprises a prismatic-shaped envelope which contains the electrodes of opposite polarities. The prismatic element is non-deformable to the touch.

In a non-limiting example, the electrochemical cell 18 is a lithium-ion electrochemical cell.

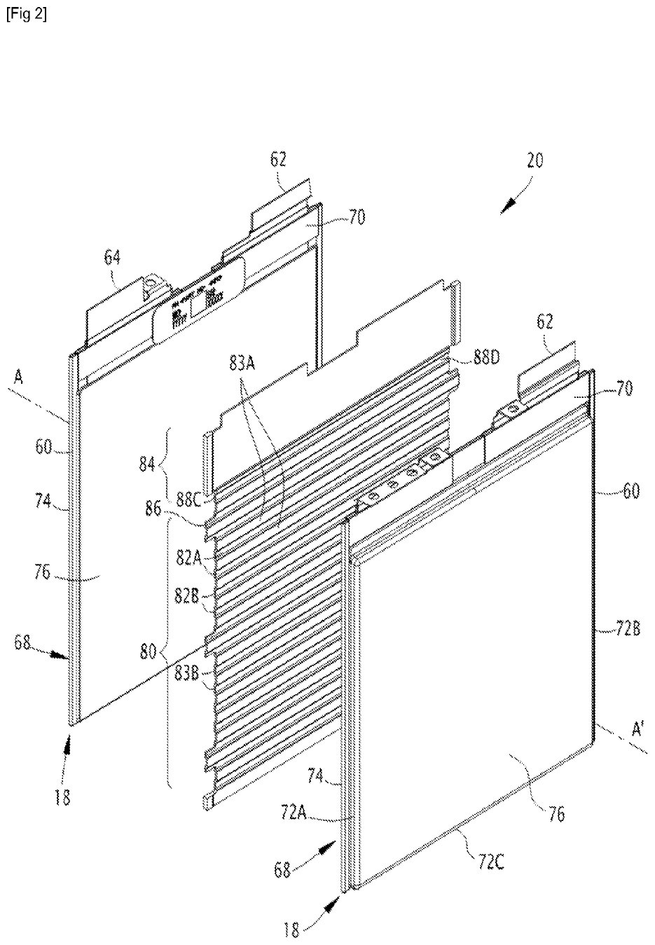

Each electrochemical cell 18 further comprises at least one tab 62 for electrical connection to the electrodes of positive polarity, and at least one tab 64 for electrical connection to the electrodes of negative polarity. In the example shown in FIG. 2, the electrochemical cell 18 further comprises a support frame 68 defining electrical connection plates 70 located between the pouch 60 and the tabs 62, 64.

The frame 68 further comprises lateral posts defining lateral edges 72A, 72B of the electrochemical cell 18.

Each flexible exterior pouch 60 has a first main face 74, and a second main face 76 located opposite the first main face 74. The main faces 74, 76 extend perpendicular to the axis A-A′, and perpendicular to the bottom 40 of the housing 12, when the stack 16 is received in the interior volume.

The main faces 74, 76 extend to the lateral edges 72A, 72B of the electrochemical cell 18. They extend between a lower edge 72C of the electrochemical cell 18 and the stiffening plates 70 under the tabs 62, 64.

Each intermediate part 20 is interposed between a pair of adjacent electrochemical cells 18. In this example, each intermediate part 20 comprises a lower region 80 provided with open channels 82A, 82B and, between the channels 82A, 82B, the support areas 83A, 83B of the intermediate part 20 on a respective face 74, 76 of an electrochemical cell 18.

Each intermediate part 20 here further comprises an upper region 84 for separating the tabs 62, 64 of the successive cells 18.

Each intermediate part 20 advantageously further comprises lateral tabs 86, protruding laterally on either side of the intermediate part 20, beyond the lateral edges 72A, 72B of the electrochemical cells 18 for guiding the holding mechanism 22.

The intermediate parts 20 are preferably made of plastic, for example made of polyamide (in particular PA66, PA12, PA12GF30).

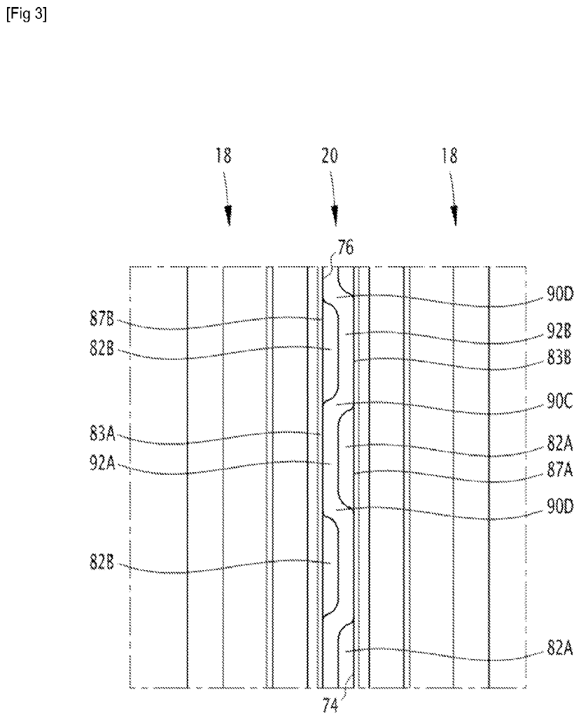

In the example shown in FIGS. 2 and 3, the channels 82A, 82B and the support areas 83A, 83B are defined by a plurality of adjacent hollow ribs. Each hollow rib internally delimits an open channel 82A opening toward a first main face 74 of a first electrochemical battery cell 18. The adjacent ribs delimit between them second channels 82B that open opposite a second face 76 of a second electrochemical cell 18 adjacent to the first electrochemical cell 18.

Referring to FIG. 3, each channel 82A opening opposite a first main face 74 is delimited laterally (here horizontally upward and downward) by two lateral partitions 90C, 90D which are common with adjacent channels 82B.

Each channel 82A is further delimited by a bottom 92A which defines a support zone 83A on the second main face 76. In this example, the bottom 92A of the channel 82A connects the lateral partitions 90C, 90D.

Likewise, each channel 82B opening opposite a second main face 76 is delimited laterally (here horizontally upward and downward) by two lateral partitions 90C, 90D which are common with adjacent channels 82A.

Each channel 82B is further delimited by a bottom 92B which defines a support zone 83B on the first main face 74. In this example, the bottom 92B of the channel 82B connects the lateral partitions 90C, 90D.

Each channel 82A, 82B opens respectively opposite a respective face 74, 76 of a respective cell 18 by a longitudinal opening 87A, 87B extending over the entire length of the channel 82A, 82B.

As can be seen in FIG. 2, each channel 82A, 82B further opens at its ends via at least a first lateral opening 88C and via a second lateral opening 88D which open in this example into opposite lateral faces of the stack 16, on either side of the axis A-A′.

Each longitudinal opening 87A, 87B of a channel 82A, 82B is located opposite the respective bottom 92A, 92B of the channel 82A, 82B opposite a respective main face 74, 76 of an electrochemical cell 18.

Advantageously, the channels 82A, 82B are all separate. Thus, no channel 82A, 82B opens into another channel 82A, 82B, or communicates with another channel 82A, 82B. The channels 82A, 82B thus define separate paths for the flow of the dielectric fluid.

In this example, the channels 82A, 82B are all parallel to each other, and parallel to the bottom 40 of the housing 12. Other example configurations of the channels 82A, 82B will be described below

Each channel 82A, 82B preferably has a cross section intended for the flow of the dielectric liquid 30, with an area greater than 0.5 mm², and preferably less than 5 mm². This section is in particular between 1 mm² and 2 mm².

The depth of each channel 82A, 82B, taken along the axis A-A′ between the bottom 92A, 92B and the longitudinal opening 87A, 87B is preferably between 0.5 and 2 times the thickness of the bottom 92A, 92B.

The number of channels 82A, 82B on each face of the intermediate part 20 is for example greater than 5, in particular greater than 10. It depends on the size of the electrochemical cell 18.

The lateral partitions 90C, 90D have a thickness generally between 0.5 mm and 1 mm.

The thickness of the intermediate part 20, taken along the axis A-A′, remains less than the thickness of each adjacent electrochemical cell 18.

Preferably, the ratio of the total area of the support areas 83A, 83B to the total area of the longitudinal openings 87A, 87B of the channels 82A, 82B on each face 74, 76 is generally between 20% and 80%, in particular between 40% and 60%. This guarantees both a wide exposure of the main faces 74, 76 in direct contact with the dielectric fluid 30 and a structural robustness of the intermediate part 20 to oppose deformation, in particular to the swelling of the electrochemical cells 18.

The upper region 84 is free of channels 82A, 82B. It extends opposite the connection tabs 62, 64 and stiffening plates 70.

The length of each channel 82A, 82B, taken linearly between the lateral openings 88C, 88D, is greater than its width, in particular 10 times its width, the width being taken at the longitudinal opening 87A, 87B,

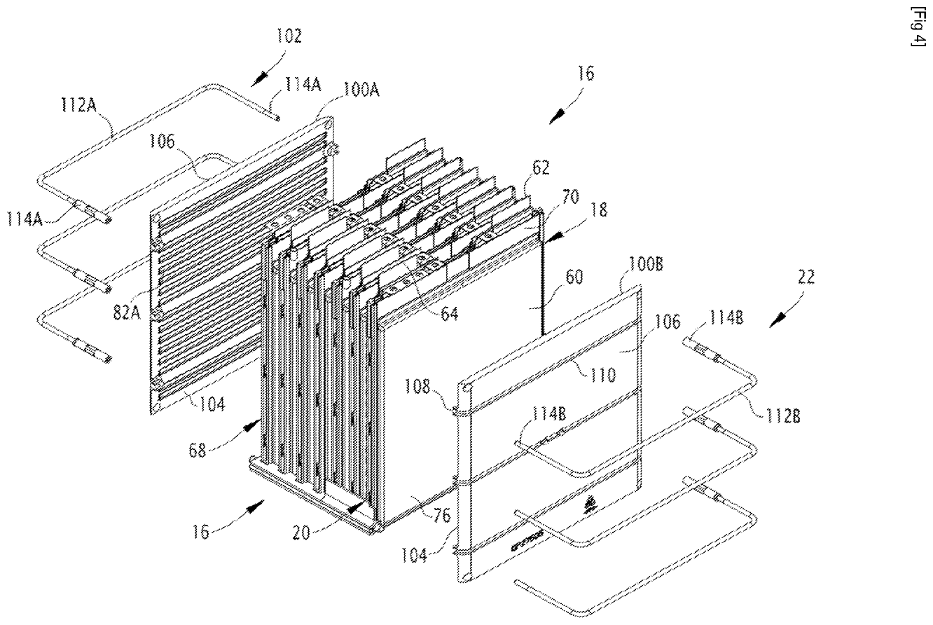

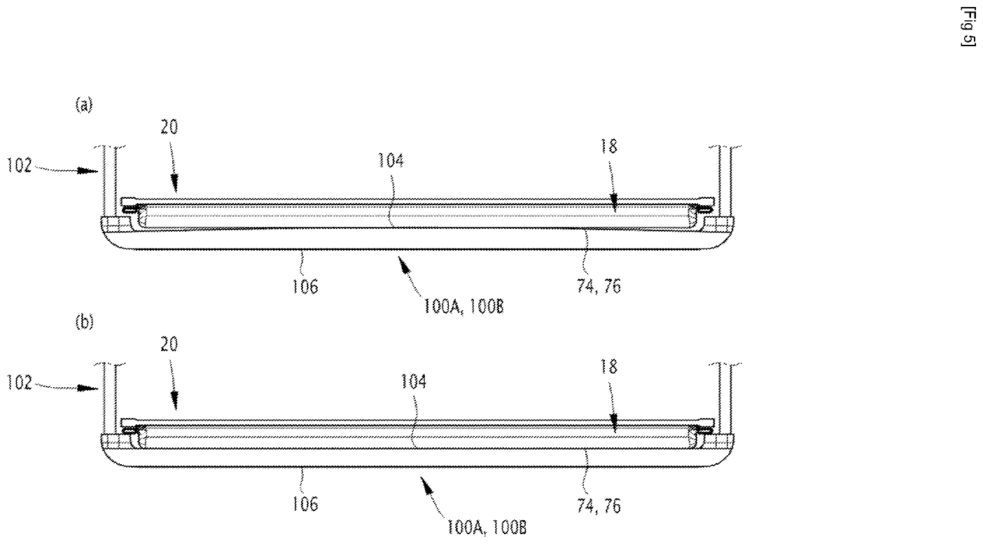

Referring to FIGS. 4 and 5, the holding mechanism 22 comprises two end flanges 100A, 100B arranged on either side of the stack 16 of electrochemical cells 18 and intermediate parts 20.

The holding mechanism 22 further comprises tie rods 102, intended to enclose the stack 16 of electrochemical cells 18 and intermediate parts 20 between the end flanges 100A, 100B.

The flanges 100A, 100B are arranged opposite two electrochemical cells 18 located at the axial ends of the stack 16 of electrochemical cells 18 and of intermediate parts 20 along the axis A-A′.

Each flange 100A, 100B has an interior face 104 intended to be placed opposite a main face 74, 76 of an electrochemical cell 18A, 18B and an exterior face 106, intended to cooperate with the tie rods 102. It further comprises guide tabs 108 for the tie rods 102, which project laterally relative to the exterior face 106.

As shown in FIG. 4, the interior face 104 of each end flange 100A, 100B defines open channels 82A, 82B intended to open opposite the main face 74, 76 opposite which the flange 100A, 100B is placed.

The channels 82A, 82B each have a structure identical to those described above for each intermediate part 20.

As shown in FIG. 5(a), in section in a horizontal plane parallel to the bottom 40 of the housing 12, the interior face 104 of each end flange 100A, 100B has at rest an inner contour curved toward the main face 74, 76, before the tie rods 102 are put into place.

Once the tie rods 102 are mounted to clamp the electrochemical cells 18 and the intermediate parts 20 interposed between the flanges 100A, 100B, flanges which are deformable, so that in cross-section in the horizontal plane parallel to the bottom 40 of the housing 12, the interior face 104 is flat and applied against the main face 74, 76 of the electrochemical cell 18A, 18B. This ensures a homogeneous contact between each end flange 100A, 100B and the electrochemical cell 18A, 18B opposite which it is placed.

In order to ensure such deformation, the flanges 100A, 100B are preferably made of plastic, in particular of polyphenylene sulfide (PPS), or alternatively of metal, in particular of aluminum.

The exterior face 106 of each flange 100A, 100B is provided with horizontal locking grooves 110, wherein each tie rod 102 is inserted.

As shown in FIG. 4, each tie rod 102 here comprises a first bracket 112A intended to be placed on one side of the stack 16, opposite the first flange 100A, and a second bracket 112B intended to be placed on another side of the stack 16, opposite the second flange 100B.

The brackets 112A, 112B are each C-shaped with free ends 114A, 114B. They are provided with a means for fastening the ends 114A, 114B to each other, for example a screw mechanism which makes it possible to adjust the distance between the flanges 100A, 100B, and therefore the clamping of the stack 16.

Alternatively (not shown), the tie rods 102 are straight and not U-shaped.

With reference to FIG. 1, the connection system 24 is intended to electrically connect the tabs 62, 64 to the terminals 26, through the electronic management system 28, when the latter is present. The connection system 24 and the electronic management system 28 are placed above the stack 16 under the cover 46, in the inner volume 14.

The connection system 24 comprises electrical connections. In the example shown in FIG. 1, it comprises an insulating part which caps the electrical connections and incorporates a connecting part for measuring the individual voltages of each electrochemical cell.

The electronic management system 28 comprises electronic components intended to control the voltage and/or the current delivered by the battery module 10 while it is discharging, and the voltage and/or current received by the battery module 10 while it is recharging.

The entire stack 16, including the electrochemical cells 18, the intermediate parts 20, and the holding mechanism 22, is immersed in the dielectric liquid 30. The connection system 24 and the electronic management system 28 are also advantageously totally immersed in the dielectric liquid 30.

The dielectric liquid 30 in particular fills the channels 82A, 82B located between the electrochemical cells 18, and enters into direct contact with the main faces 74, 76 of the electrochemical cells 18 through the longitudinal openings 87A, 87B.

Thus, a heat exchange by convection occurs directly at each main face 74, 76 of each electrochemical cell 18, between the dielectric liquid 30 and the electrochemical cell 18, allowing the very efficient discharge of the calories generated in the electrochemical cell 18.

Preferably, the dielectric fluid 30 is circulated in the interior volume 14 by means of a pump of the cooling circuit 32.

Dielectric liquid 30 intended to be heated is conveyed into the interior volume 14 through the supply inlet 48, to circulate from bottom to top and laterally from the supply inlet 48 to the discharge outlet 50 through the channels 82A, 82B.

The dielectric fluid 30 thus enters each channel 82A, 82B via a first end opening 88C, passes over a main face 74, 76 along the longitudinal opening 87A, 87B where it heats up, and emerges outside the stack 16 via a second end opening 88D, before joining the discharge outlet 50.

The dielectric liquid 30 advantageously has a resistivity greater than 50 GQ and a breaking voltage greater than 40 kV for an air gap of 2.5 mm, preferably between 45 KV and 55 kV for an air gap of 2.5 mm.

The dielectric liquid 30 further has a density of less than 1, for example between 0.7 and 0.9, and a low viscosity for example less than 3.3 mPa·s at 25° C., as measured by the ASTM D7042 standard.

The mounting of the battery module 10 is particularly simple to carry out.

The electrochemical cells 18 and the intermediate parts 20 are provided, and are mounted alternately against one another, each intermediate part 20 being inserted between two adjacent electrochemical cells 18. Then, end flanges 100A, 100B are placed at the ends of the stack 16. The brackets 112A, 112B are then inserted into the grooves 110 in contact with the exterior face 106 of each end flange 100A, 100B.

The brackets 112A, 112B are inserted into the tabs 86, 108 on either side of the intermediate parts 20 and the flanges 100A, 100B.

The free ends 114A, 114B of the brackets 112 are then joined together, and a tightening is applied so that the tie rods 102 hold the stack 16 in compression.

The connection system 24 and the electronic management system 28 are then mounted on the stack 16.

Then, the stack 16 is introduced into the interior volume 14 of the housing 12 through the upper opening 44. The cover 46 is then placed in order to close the upper opening 44.

The inner volume 14 of the battery module 10 is then filled with cooling liquid 30 and is connected to the cooling circuit 32.

In operation, during a discharge phase of the battery module 10, a current and a voltage are delivered by the terminals 26 of the battery module 10. Conversely, during a recharge phase, a current and a voltage are applied to the terminals 26 of the battery module 10.

The heat generated in the electrochemical cells 18 is evacuated by circulating the dielectric fluid 30 from the supply inlet 48, in the interior volume 14 around the stack 16, through the first end openings 88C of the channels 82A, 82B then along the channels 82A, 82B in contact with the main faces 74, 76 of the electrochemical cells 18.

The dielectric fluid 30 is then heated by convection, and is evacuated through the second end openings 88D, then through the liquid evacuation outlet before being cooled in the circuit 32.

The shape of the channels 82A, 82B delimited by the intermediate parts 20 ensures an appropriate flow of dielectric liquid 30 in contact with the faces 74, 76 of the electrochemical cells 18, while allowing the intermediate parts 20 to retain excellent mechanical contact with the electrochemical cells 18.

The presence of the support areas 83A, 83B prevents the swelling of the electrochemical cells 18 and maintains the integrity of the stack 16, even if the delivered power is high, or/and when recharging. The reduced dimensions of the channels 82A, 82B relative to the volume present outside the channels 82A, 82B further ensures an effect of accelerating the flow of dielectric fluid 30 within the channels 82A, 82B, which increases the heat exchanged at the channels 82A, 82B and therefore the cooling capacity within the battery module 10.

The flow of a dielectric fluid 30 as defined above further guarantees that the battery module 10 is reliable and safe, while offering high performance in terms of cooling. This performance is due in particular to direct convection from the electrochemical cells 18 to the dielectric liquid 30.

In addition, the dielectric fluid 30 filling the entire inner volume 14 cools the various connection tabs 62 and 64 of each electrochemical cell 18 and the electronic management system 28 which are immersed.

The advantageous properties mentioned above in terms of cooling, mechanical robustness, reliability and safety are obtained while maintaining maximum compactness of the battery module 10, in particular relative to existing solutions.

This is the case with respect to conventional exchangers, which are interposed between electrochemical cells, but wherein the heat exchange between the cooling liquid and the wall of the cells is carried out only by contactless thermal conduction.

Furthermore, since the stack 16 is completely immersed in the interior volume 14, it is not necessary to provide a storage capacity of dielectric liquid 30, as the interior volume 14 constitutes this storage capacity.

The mass and volume gain relative to a conventional battery module can therefore be on the order of 30% to 50%, in particular when the intermediate parts 20 are made of plastic.

In addition, the configuration of the channels 82A, 82B can be modified to adapt to various positions of the supply inputs 48 and discharge outlets 50.

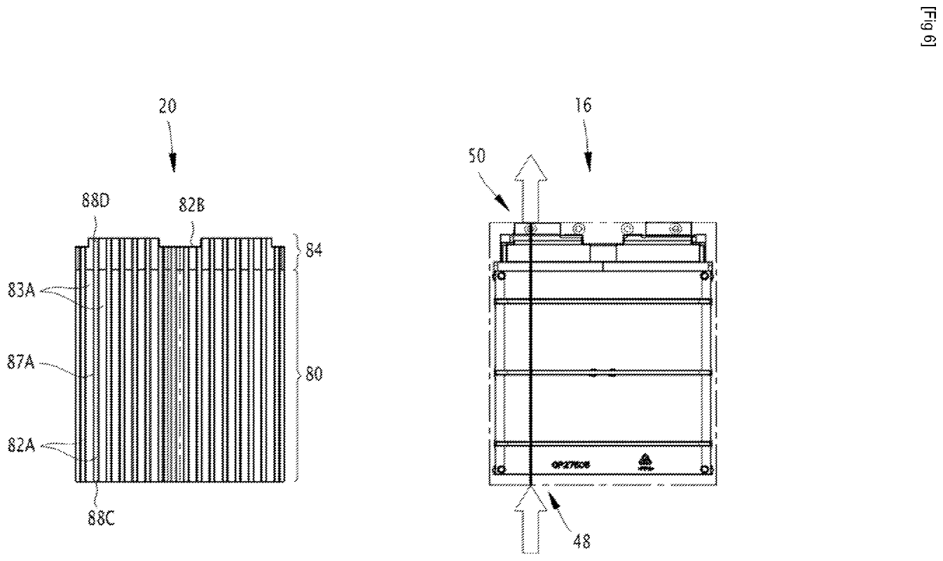

In the example of FIG. 6, the liquid supply inlet 48 is located at the bottom of the housing 12. The liquid discharge outlet 50 is located in the cover 46.

In this case, the channels 82A, 82B extend vertically, perpendicular to the axis A-A′ and to the bottom 40. The first openings 88C open into a lower face of the stack 16, while the second openings 88D open into an upper face of the stack 16. The intermediate parts 20 of FIG. 6 are further different from those of FIG. 2 in that the upper region 84 is also provided with channels 82A, 82B.

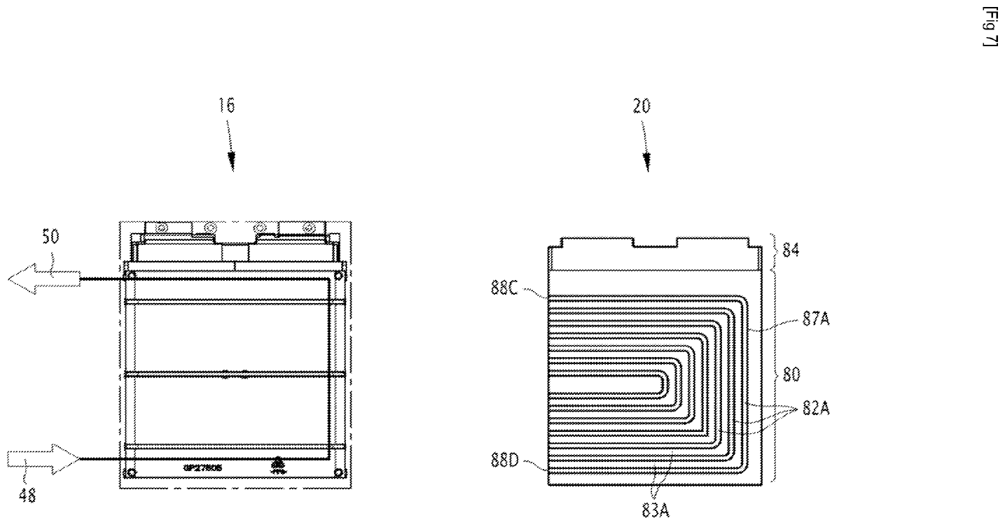

In the variant shown in FIG. 7, the liquid supply inlet 48 and the liquid discharge outlet 50 are located on the same lateral wall 42, on the same side of the housing 12.

In this case, the first openings 88C and the openings 88D open into the same lateral face of the stack 16. Each channel then is U-shaped with a half-turn opposite the openings 88C, 88D.

In the example shown in FIG. 7, the channels 82A, 82B further adopt a nesting configuration with an outermost channel 82A, 82B having the openings 88C, 88D that are furthest apart and the U-shape of greatest width. The outermost channel 82A, 82B contains all of the channels 82A, 82B having a U-shape of lesser width, each channel 82A, 82B having a U-shape of lesser width being nested in a channel 82A, 82B having a U-shape of greater width.

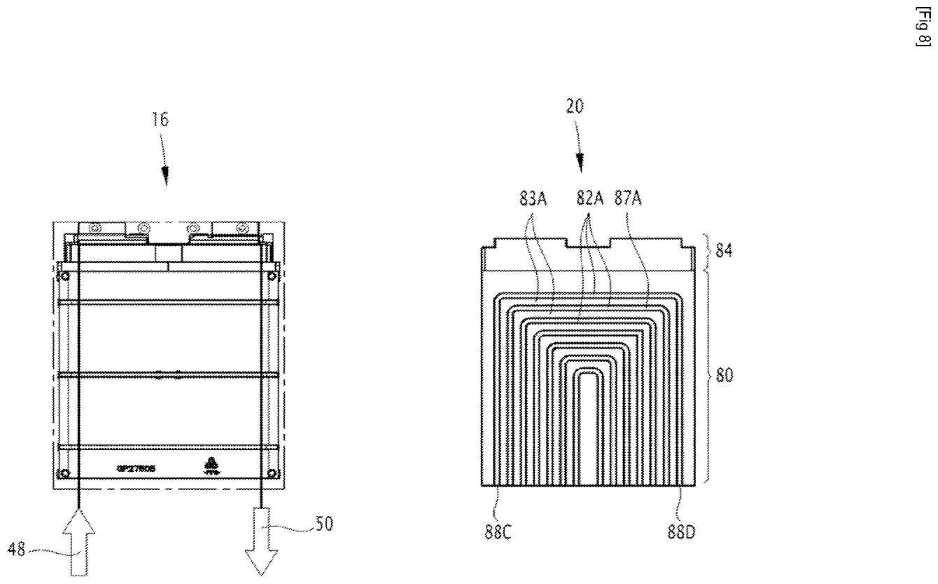

The variant of FIG. 8 differs from that of FIG. 7 in that the supply inlet 48 and the discharge outlet 50 open into the bottom 40.

The end openings 88C, 88D of each channel 82A, 82B all open into a lower face of the stack 16.

Each channel 82A, 82B also has a U shape, the channels 82A, 82B advantageously being in a nesting configuration, as described above.

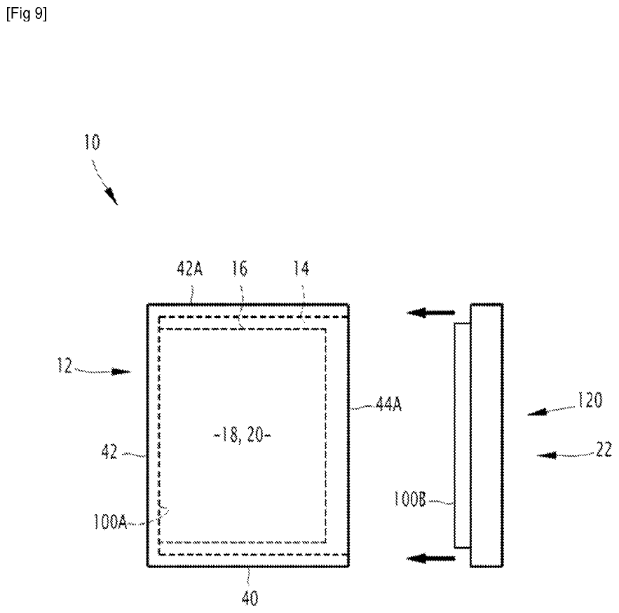

In another variant shown in FIG. 9, the housing 12 is provided with an upper wall 42A that is fixed relative to the lateral walls 42.

The lateral walls 42 define a lateral access opening 44 to the interior volume in a lateral face of the housing 12.

In this example, the holding mechanism 22 lacks tie rods 102. The first flange 100A is formed by the interior face of a lateral wall 42. The second flange 100B is formed by a hatch 120, able to close the access opening 44, by compressing the electrochemical cells 18 and the intermediate parts 20 against one another to hold them in abutment against the flange 100A.

This variant further reduces the number of parts necessary to produce the stack 16, increases the compactness, while retaining the advantageous properties described above.

1. A battery module comprising:
a housing defining an interior volume;
a stack comprising:
a plurality of electrochemical cells stacked in the interior volume;
at least one intermediate part interposed between each pair of adjacent electrochemical cells;
a mechanism for holding the stack suitable for clamping the electrochemical cells and the intermediate parts against one another; the stack being contained in the interior volume;
at least one dielectric liquid for cooling the stack,
wherein the dielectric fluid fills the interior volume, the stack being totally immersed in the dielectric fluid,
the or each intermediate part defining at least one open channel for flow of the dielectric fluid, the open channel for flow of the dielectric fluid opening onto the periphery of the stack to allow the dielectric fluid to flow through the stack and opening facing a main face of at least one electrochemical cell, wherein said face is applied against the intermediate part, in order to place the main face of the electrochemical cell into contact with the dielectric fluid.

2. The battery module according to claim 1, wherein the at least one intermediate part defines a plurality of open channels for circulating the dielectric fluid separated from each other.

3. The battery module according to claim 2, wherein the or each intermediate part defines at least one first open channel for flow of the dielectric fluid opening toward a first main face of a first electrochemical cell adjacent to the intermediate part, and closed toward a second main face of a second electrochemical cell adjacent to the intermediate part, located opposite the first electrochemical cell relative to the intermediate part, the intermediate part comprising at least one second open channel for flow of the dielectric fluid opening toward the second main face of the second electrochemical cell, and closed toward the first main face of the first electrochemical cell.

4. The battery module according to claim 3, wherein a bottom of the first open channel for flow of the dielectric fluid is applied against the second main face of the second electrochemical cell, a bottom of the second open channel for flow of the dielectric fluid being applied against the first main face of the first electrochemical cell.

5. The battery module according to claim 1, wherein the open channel for flow of the dielectric fluid opens into the periphery of the stack via at least two distinct openings.

6. The battery module according to claim 5, wherein the two distinct openings open into two distinct faces of the stack, advantageously in two opposite or adjacent faces of the stack, or wherein the two distinct openings open into the same face of the stack.

7. The battery module according to claim 1, wherein the area of the cross-section of each open channel of the dielectric liquid flow is less than 2 mm², and in particular between 0.5 mm² and 2 mm².

8. The battery module according to claim 1, wherein the housing defines an inlet for supplying dielectric liquid into the interior volume and an outlet for discharging dielectric fluid out from the interior volume, the supply inlet and the discharge outlet being intended to be connected to a cooling circuit of the dielectric fluid advantageously comprising a pump.

9. The battery module according to claim 1, wherein the holding mechanism comprises two end flanges, arranged on either side of the stack, and at least one tie rod connecting the two end flanges.

10. The battery module according to claim 9, wherein at least one of the end flanges comprises an inner face intended to be placed opposite an electrochemical cell of the stack, the inner face being curved before clamping the stack using the tie rod and flattening on a main face of an electrochemical cell after the stack is clamped using the tie rod.

11. The battery module according to claim 1, wherein the housing comprises a lateral access opening and an opposite internal face located opposite the lateral access opening, the holding mechanism comprising at least one hatch for closing the lateral access opening able to compress the stack between the hatch and the opposite face.

12. The battery module according to claim 1, wherein each electrochemical cell defines at least one electrical connection tab protruding from the stack, the electrical connection tabs being immersed in the dielectric fluid.

13. The battery module according to claim 12, comprising at least one connection system and/or at least one electronic system for managing the battery module connected to each electrical connection tab, the connection system and/or the electronic management system being immersed in the dielectric liquid.

14. The battery module according to claim 1, wherein each electrochemical cell comprises a pouch, in particular is a lithium ion electrochemical cell in a pouch format or wherein each electrochemical cell comprises an element of prismatic shape, the dielectric liquid present in the or each open channel for flow of the dielectric fluid being in contact with the pouch or the prismatic element.

15. A battery, comprising at least one battery module according to claim 1.

16. A vehicle, in particular a motor vehicle, spacecraft, or aircraft, comprising at least one battery according to claim 15.
